(19) United States
(12) Patent Application Publication
(10) Pub. No.: US 2009/0130464 A1
(43) Pub. Date: May 21, 2009

(54) Antistatic Hard Coat Film

(76) Inventors: Hikaru Nishinaga, Saitama (JP); Keiichi Kitahara, Saitama (JP); Masato Saito, Saitama (JP); Kazushige Matsumoto, Saitama (JP); Masuo Koyama, Saitama (JP); Yoshihisa Kimura, Tokyo (JP)

Correspondence Address: BACON & THOMAS, PLLC, 625 SLATERS LANE, FOURTH FLOOR, ALEXANDRIA, VA, 22314-1176, US

(21) Appl. No.: 12/224,227

(22) PCT Filed: Feb. 13, 2007
(86) PCT No.: PCT/JP2007/052453

§ 371 Date: Aug. 21, 2008

(30) Foreign Application Priority Data
Feb. 22, 2006 (JP) 2006-045163

(51) Int. Cl. B32B 27/20

(52) U.S. Cl. 428/447

(57) ABSTRACT

An antistatic hard coat film showing antistatic property and antireflection property for outer lights as well as superior hard coat properties such as superior surface hardness and antiscratching property is provided. The antistatic hard coat film of the present invention comprises an antistatic hard coat layer formed from an ionizing radiation curable resin, a pigment and a polymer antistatic agent having an organopolysiloxane unit and a quaternary ammonium salt unit, and the hard coat layer contains 1 to 5% by weight of the pigment. Weight ratio of the ionizing radiation curable resin and the polymer antistatic agent is preferably 6:4 to 5:5.

### TECHNICAL FIELD

The present invention relates to an antistatic hard coat film which has antistatic property and antireflection property for external lights as well as superior hard coat properties such as superior surface hardness and antiscratching property.

### BACKGROUND ART

It is known that a hard coat layer is formed as an outermost surface layer on a base film as a general means for increasing surface hardness of cover films such as protective films and thereby improving antiscratching property thereof. It is prevalent that a pigment is added to such a hard coat layer to prevent reflection of lights of fluorescent lights and so forth.

However, since such a hard coat layer shows superior insulating property, it has a problem that it is easily charged with static electricity etc., and adhesion of dusts to product surfaces consisting of such a hard coat layer degrades visibility.

In order to solve such a problem, it is possible to provide an antistatic layer or conductive layer in addition to the hard coat layer. However, there may arise other problems such as exfoliation of the layer because adhesion of such a layer to the hard coat layer is bad. Therefore, it is prevalent that an antistatic agent is added to the hard coat layer. As the antistatic agent used for this purpose, low molecular antistatic agents and metal fine particles are used (Patent document 1).

Patent document 1: Japanese Patent Unexamined Publication (KOKAI) No. 2005-43647 (claims)

### DISCLOSURE OF THE INVENTION

Object to be Achieved by the Invention

However, addition of a low molecular antistatic agent still has a problem, that is, even if a low molecular antistatic agent is added, it does not favorably exude on the hard coat layer surface, and thus antistatic property cannot be obtained. Further, if metal fine particles are added, there arises a problem that reflection of outer lights cannot be prevented, even if a pigment is added.

Meanwhile, as polymer antistatic agents, those utilizing a hydrophilic polymer as a base material and cationic polymer compounds are known. When such polymer antistatic agents are used, reflection of outer lights can be prevented by matting, and antistatic property can also be attained. However, the leveling property of the coated film becomes bad, and unevenness of the coated film is generated. If a leveling agent usually used in such a case is added, antistatic property can no longer be obtained, although unevenness of the coated film can be eliminated.

The present invention was accomplished in view of the aforementioned situation, and aims at providing an antistatic hard coat film which shows antistatic property and antireflection property for outer lights as well as superior hard coat properties such as superior surface hardness and antiscratching property.

### Means for Achieving the Object

The antistatic hard coat film of the present invention, which achieves the aforementioned object, comprises a base material and an antistatic hard coat layer formed from an ionizing radiation curable resin, a pigment and a polymer antistatic agent having an organopolysiloxane unit and a quaternary ammonium salt unit and provided on at least one surface of the base material, wherein the content of the pigment is 1 to 5% by weight of the total solid content of the hard coat layer. The content of the pigment is preferably 3% by weight or less.

Weight ratio of the ionizing radiation curable resin and the polymer antistatic agent is preferably 6:4 to 5:5.

### EFFECT OF THE INVENTION

According to the present invention, by using a polymer antistatic agent having an organopolysiloxane unit and a quaternary ammonium salt unit as an antistatic agent for the hard coat layer containing an ionizing radiation curable resin, and adding a small amount of a pigment to the hard coat layer, high antistatic property and antireflection property for outer lights can be obtained. There is thereby provided an antistatic hard coat film showing favorable antistatic property, antireflection property for outer lights and hard coat properties such as surface hardness and antiscratching property.

### BEST MODE FOR CARRYING OUT THE INVENTION

Hereafter, embodiments of the antistatic hard coat film of the present invention will be explained.

The base material is not particularly limited, and various polymer films and sheets, paper, glass and other molded products formed from various materials can be suitably used. The base material may be either transparent or opaque. However, when the film is used as an optical member, optical characteristics thereof such as transparency and refractive index should be taken into consideration, and impact resistance, heat resistance, durability and so forth are further taken into consideration. As such a base material, those consisting of, for example, one or more kinds of polyester type resins, acrylic type resins, acrylic urethane type resins, polyester acrylate type resins, polyurethane acrylate type resins, epoxy acrylate type resins, urethane type resins, epoxy type resins, polycarbonate type resins, cellulose type resins, acetal type resins, vinyl type resins, polyethylene type resins, polystyrene type resins, polypropylene type resins, polyamide type resins, polyimide type resins, melamine type resins, phenol type resins, silicone type resins and fluorocarbon type resins can be used. Although thickness of the base material is not particularly limited so long as handling thereof is not obstructed, it is about 25 to 500 μm, preferably 50 to 300 μm.

The antistatic hard coat layer is formed on at least one surface of the base material, and is formed from an ionizing radiation curable resin, a pigment and a polymer antistatic agent having an organopolysiloxane unit and a quaternary ammonium salt unit.

As the ionizing radiation curable resin, photopolymerizable prepolymers curable by crosslinking upon irradiation of ionizing radiation (ultraviolet radiation or electron beam) can be used. As such photopolymerizable prepolymers, acrylic type prepolymers which have two or more acryloyl groups in one molecule and form a three-dimensional reticular structure upon curing by crosslinking are particularly preferably used. As the acrylic type prepolymers include polyurethane acrylates, polyester acrylates, polyepoxy acrylates, melamine acrylates, polyfluoroalkyl acrylates, silicone acrylates and so forth can be used. Although these acrylic type prepolymers can be used independently, they are preferably used as a mixture with a photopolymerizable monomer in order to improve crosslinking curable property and further improve hardness of the surface protection film.

As the photopolymerizable monomer, one or more kinds of monofunctional acrylic monomers such as 2-ethylhexyl acrylate, 2-hydroxyethyl acrylate, 2-hydroxypropyl acrylate and butoxyethyl acrylate, bifunctional acrylic monomers such as 1,6-hexanediol diacrylate, neopentylglycol diacrylate, diethylene glycol diacrylate, polyethylene glycol diacrylate and hydroxypivalic acid ester neopentylglycol diacrylate, polyfunctional acrylic monomers such as dipentaerythritol hexaacrylate, trimethylpropane triacrylate and pentaerythritol triacrylate, and so forth are used.

When the antistatic hard coat layer is cured by ultraviolet irradiation, it is preferable to use additives such as photopolymerization initiators and photopolymerization enhancers, besides the aforementioned photopolymerizable prepolymers and photopolymerizable monomers.

Examples of the photopolymerization initiators include acetophenone, benzophenone, Michler's ketone, benzoin, benzyl methyl ketal, benzoyl benzoate, α-acyl oxime ester, thioxanthones, and so forth.

The photopolymerization enhancers can accelerate the curing rate by reducing polymerization disturbance caused by oxygen in the air at the time of curing, and examples include p-dimethylaminobenzoic acid isoamyl ester, p-dimethylaminobenzoic acid ethyl ester, and so forth.

As the ionizing radiation curable resin, besides the aforementioned resins, resins having light stabilizing property such as resins having ultraviolet absorbing property can be used. Examples of the resin having ultraviolet absorbing property include ultraviolet absorbing acrylic resins, and copolymers of benzotriazole and (meth)acrylic acid ester are preferred. Moreover, as the photopolymerizable monomer, polyfunctional acrylic monomers showing ultraviolet absorbing property, such as monomers having a bisbenzotriazolylphenol structure, may be used. By using such an ionizing radiation curable resin having ultraviolet absorbing property, degradation of the base material by ultraviolet radiation can be prevented.

If the ionizing radiation curable resin is chosen so that it should cure in a ultraviolet region (wavelength region) different from the ultraviolet region (wavelength region) of which ultraviolet rays are absorbed by the resin, the ionizing radiation curable resin should have ultraviolet absorbing property.

Moreover, a light stabilizer, for example, hindered amine type light stabilizers generically called HALS, or an ultraviolet absorber can be added to the ionizing radiation curable resin. The ultraviolet absorber is not particularly limited, and examples include conventionally known ultraviolet absorbers such as salicylic acid type compounds, cyanoacrylate type compounds, benzophenone type compounds and benzotriazole type compounds, and so forth. Among these, benzophenone type compounds and/or benzotriazole type compounds are preferred in view of weather resistance, for example, at the time of using the film in the outdoors.

When an ionizing radiation curable resin having ultraviolet absorbing property is used, and when an ultraviolet absorber is used, the photopolymerization initiator for the ionizing radiation curable resin mentioned above can be used. In such a case, it is preferable to use a photopolymerization initiator showing an absorption peak at a wavelength different from the ultraviolet absorption peak of the ultraviolet absorber by 20 nm or more. The surface protection layer can be thereby sufficiently cured, and superior hard coat properties can be imparted.

As for the ultraviolet absorbing property of the surface protection layer, it is sufficient that it can reduce light transmission at a wavelength of 380 nm to about 40 to 70%. Although the content of the ultraviolet absorber in the hard coat layer changes depending on thickness of the layer, it may be not less than about 0.5% by weight and not more than about 10% by weight, preferably not less than about 1% by weight and not more than about 7% by weight, of the hard coat layer.

By choosing a content of the ultraviolet absorber in such a range, degradation of the hard coat properties and degradation of the hard coat layer and plastic film by ultraviolet radiation can be prevented with a minimum content of the ultraviolet absorber in the hard coat layer, and at the same time, stress of ultraviolet radiation on the hard coat layer can be reduced to improve durability of the ultraviolet shielding property of the hard coat layer.

Since thickness of the hard coat layer may change depending on the content of the light stabilizer and so forth, it cannot be generally defined. However, when the hard coat properties are taken into consideration, it is preferably about 1 to 15 μm, more preferably about 3 to 10 μm. With a thickness of the hard coat layer of 1 μm or larger, sufficient hard coat properties and required light stability such as ultraviolet shielding property can be imparted. Further, with a thickness of 15 μm or smaller, generation of curl due to shrinkage of the hard coat layer upon curing can be prevented, undercure of the layer can be prevented, and exudation of the light stabilizers such as the ultraviolet absorber can be prevented.

Examples of the pigment used for the present invention include inorganic pigments such as silica, clay, talc, calcium carbonate, calcium sulfate, barium sulfate, aluminum silicate, titanium oxide, synthetic zeolite, alumina and smectite, and organic pigments such as resin beads consisting of styrene resin, urethane resin, benzoguanamine resin, silicone resin, acrylic resin or the like, and hollow resin beads formed from them as raw materials.

Addition amount of the pigment for preventing reflection of outer lights is about 1 to 5% by weight, preferably about 1 to 3% by weight, of the total solid content of the hard coat layer. With a content of 1% by weight as the lower limit or larger, reflection of outer lights can be prevented. With a content of 5% by weight as the upper limit or smaller, degradation of surface hardness and antiscratching property of the hard coat layer can be prevented. By using the ionizing radiation curable resin and the polymer antistatic agent having an organopolysiloxane unit and a quaternary ammonium salt unit in combination, reflection of outer lights can be prevented even with a smaller amount of the pigment compared with the case where the ionizing radiation curable resin is used alone.

The polymer antistatic agent imparts antistatic property to the hard coat layer, and it is a polymer having an organopolysiloxane unit and a quaternary ammonium salt unit, and may have polymerizable functional groups such as (meth)acryloyl group on side chains as required. Since the antistatic agent having polymerizable functional groups chemically bonds to the ionizing radiation curable resin as a component of the hard coat layer upon ultraviolet radiation or electron beam irradiation, it can be fixed in the hard coat layer not to exude from the hard coat layer and thereby defluxion of the antistatic agent due to washing with water, wiping or the like can be reduced.

Since the polymer antistatic agent can dispose the groups imparting antistatic property on the hard coat layer surface by the organopolysiloxane structure in the molecule, it can provide more sufficient antistatic property even in the same amount as those of conventional low molecular antistatic agents, without degrading the hard coat properties such as surface hardness or antiscratching property.

On the other hand, only with a polymer antistatic agent having only a quaternary ammonium salt unit, leveling property is degraded, although antistatic property can be obtained. If a leveling agent is added, the leveling agent covers the hard coat layer surface, and prevent the quaternary ammonium salt from emerging on the surface, and therefore antistatic property can no longer be obtained. In contrast, if a polymer having both an organopolysiloxane unit and a quaternary ammonium salt unit is used as in the present invention, the organopolysiloxane structure has leveling property, therefore quaternary ammonium salts can be disposed on the hard coat layer surface without requiring use of another leveling agent, and therefore leveling property and antistatic property can be imparted to the hard coat layer.

As the polymer antistatic agent having both an organopolysiloxane unit and a quaternary ammonium salt unit, for example, those described in Patent documents 2 and 3 can be used.

Patent document 2: Japanese Patent Unexamined Publication No. 10-279833
Patent document 3: Japanese Patent Unexamined Publication No. 2000-80169

Weight ratio of the ionizing radiation curable resin and the polymer antistatic agent is determined in consideration of the content of the quaternary ammonium salt unit contained in the polymer antistatic agent. For example, content of quaternary ammonium salt units contained in the available polymer antistatic agents is less than 40% by weight, and in the case of these polymer antistatic agents, the weight ratio of the ionizing radiation curable resin and the polymer antistatic agent is 8:2 to 4:6, preferably 7:3 to 5:5, more preferably 6:4 to 5:5. It is not preferred that the polymer antistatic agent is contained in a large amount, since quaternary ammonium salts are highly hygroscopic, therefore the hard coat layer becomes cloudy uneven coated film due to humidity, and thus appearance thereof is degraded. Moreover, with only the polymer antistatic agent, hard coat properties become insufficient. On the other hand, if amount of the ionizing radiation curable resin increases, the leveling property of the coated film is degraded, and optical characteristics become uneven. As for surface hardness, hardness of at least about 2 to 3H is practically sufficient.

The hard coat layer may contain various additives, such as lubricants, fluorescent whitening agents, dyes, flame retardants, antibacterial agents, antifungal agents, antioxidants, plasticizers, leveling agents, flow regulators, antifoams, dispersing agents and crosslinking agents, to such an extent that the effect of the present invention should not be degraded.

The antistatic hard coat layer can be formed by mixing the ionizing radiation curable resin, the pigment and the polymer antistatic agent, as well as other resin, additive and dilution solvent added as required to prepare a coating solution, applying the solution by a conventionally known method such as bar coating, die coating, blade coating, spin coating, roll coating, gravure coating, curtain flow coating, spray coating and screen printing, drying the coated layer, and optionally curing the layer by irradiating the layer with ionizing radiation as required.

As for the method for irradiating ionizing radiation, the irradiation can be attained by irradiating a ultraviolet ray in a wavelength region of 100 to 400 nm, preferably 200 to 400 nm, emitted from an ultra high pressure mercury lamp, a high pressure mercury lamp, a low pressure mercury lamp, carbon arc, a metal halide lamp, or the like, or by irradiating an electron beam in a wavelength region of 100 nm or smaller emitted from a scanning type or curtain type electron beam accelerator.

Moreover, in order to improve adhesion between the hard coat layer and the base material, the base material may be optionally subjected to an easy adhesion treatment.

The antistatic hard coat film of the present invention can be used for uses in surface protection of liquid crystal displays, plasma displays and rear projection displays, surface protection of touch panels, and so forth.

### EXAMPLES

Hereafter, the present invention will be further explained with reference to examples. The term and symbol “part” and “%” are used on weight basis, unless specifically indicated.

### Example 1

On a base material consisting of a polyester film having a thickness of 188 μm (Lumirror U34, Toray Industries, Inc.), a coating solution for hard coat layer having the following composition was applied by bar coating so as to obtain a dry thickness of 5 μm, dried at 70° C. for 2 minutes and cured by ultraviolet irradiation from a high pressure mercury lamp to form a hard coat layer and thereby prepare an antistatic hard coat film of the present invention.

<Coating solution for hard coat layer>

| | | |
|---|---|---|
| Ultraviolet absorbing ionizing radiation | 34 | parts |
| curable resin (Aurex 359, solid content: 70% | | |
| Chugoku Marine Paints, Ltd.) | | |
| Polymer antistatic agent having | 32 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 34 | parts |
| Toluene | 34 | parts |

### Example 2

An antistatic hard coat film of Example 2 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 30 | parts |
| (ACRYDIC 17-806, solid content: 80% | | |
| Dainippon Ink &Chemicals, Inc.) | | |
| Polymer antistatic agent having | 32 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 36 | parts |
| Toluene | 36 | parts |

### Example 3

An antistatic hard coat film of Example 3 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 25 | parts |
| (ACRYDIC 17-806, solid content: 80% | | |
| Dainippon Ink &Chemicals, Inc.) | | |
| Polymer antistatic agent having | 40 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 33 | parts |
| Toluene | 33 | parts |

### Example 4

An antistatic hard coat film of Example 4 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 20 | parts |
| (ACRYDIC 17-806, solid content: 80% | | |
| Dainippon Ink &Chemicals, Inc.) | | |
| Polymer antistatic agent having | 48 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 34 | parts |
| Toluene | 34 | parts |

### Example 5

An antistatic hard coat film of Example 5 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 40 | parts |
| (ACRYDIC 17-806, solid content: 80% | | |
| Dainippon Ink &Chemicals, Inc.) | | |
| Polymer antistatic agent having | 16 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 37 | parts |
| Toluene | 37 | parts |

### Example 6

An antistatic hard coat film of Example 6 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 25 | parts |
| (ACRYDIC 17-806, solid content: 80% | | |
| Dainippon Ink &Chemicals, Inc.) | | |
| Polymer antistatic agent having | 40 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 2.4 | part |
| diameter: 5 μm, Soken Chemical & | | |
| Engineering Co., Ltd.) | | |
| Methyl ethyl ketone | 34 | parts |
| Toluene | 34 | parts |

### Comparative Example 1

An antistatic hard coat film of Comparative Example 1 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 50 | parts |
| (ACRYDIC 17-806, solid content: 80% | | |
| Dainippon Ink &Chemicals, Inc.) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 40 | parts |
| Toluene | 40 | parts |

### Comparative Example 2

An antistatic hard coat film of Comparative Example 2 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 50 | parts |
| (ACRYDIC 17-806, solid content: 80% | | |
| Dainippon Ink &Chemicals, Inc.) | | |
| Metal antistatic agent | 100 | parts |
| (Seikabeam HC15, solid content: 30%, | | |
| Dainichiseika Color &Chemicals Mfg. | | |
| Co., Ltd.) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 40 | parts |
| Toluene | 40 | parts |

### Comparative Example 3

An antistatic hard coat film of Comparative Example 3 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Ionizing radiation curable resin | 25 | parts |
| (ACRYDIC 17-806, solid content: 80% | | |
| Dainippon Ink &Chemicals, Inc.) | | |
| Polymer antistatic agent not having | 100 | parts |
| organopolysiloxane unit and quaternary | | |
| ammonium salt unit (Seikabeam EPF-EPR2, | | |
| solid content: 20%, Dainichiseika Color & | | |
| Chemicals Mfg. Co., Ltd.) | | |
| Acrylic resin beads (MX500KS, mean particle | 0.7 | part |
| diameter: 5 μm, Soken Chemical & | | |
| Engineering Co., Ltd.) | | |
| Leveling agent | 0.5 | part |
| (Paintad M, Dow Corning Co., Ltd.) | | |
| Methyl ethyl ketone | 5 | parts |
| Toluene | 5 | parts |

### Comparative Example 4

An antistatic hard coat film of Comparative Example 4 was prepared in the same manner as that of Example 1 except that a coating solution for hard coat layer having the following composition was used instead of the coating solution for hard coat layer of Example 1.

<Coating solution for hard coat layer>

| | | |
|---|---|---|
| Polymer antistatic agent having | 80 | parts |
| organopolysiloxane unit and quaternary | | |
| ammonium salt unit (Yupimer UV H6100, | | |
| solid content: 50%, Mitsubishi Chemical | | |
| Corporation) | | |
| Acrylic resin beads (MX500KS, mean particle | 0.7 | part |
| diameter: 5 μm, Soken Chemical & | | |
| Engineering Co., Ltd.) | | |
| Methyl ethyl ketone | 25 | parts |
| Toluene | 25 | parts |

The hard coat films of Examples 1 to 6 and Comparative Examples 1 to 4 were evaluated for the following items. The results are shown in Table 1.

### <Antistatic Property>

Surface resistance (Ω/□) was measured for hard coat layer surface of each hard coat film in an environment of a temperature of 20° C. and a humidity of 60% RH with a high resistance meter (3329A, Hewlett Packard Co.). The results lower than 1.0×10¹¹Ω/□ are indicated with the symbol “∘”, and the results not lower than 1.0×10¹¹Ω/□ are indicated with the symbol “x”.

### <Antireflection Property>

Each hard coat film was laminated on a CRT screen displaying images. When the images became invisible due to reflection of outer lights, the result is indicated with the symbol x, when the images became hard to see, the result is indicated with the symbol “Δ”, and when images did not become hard to see, the result is indicated with the symbol “∘”.

### <Whitening>

Each hard coat film was superimposed on a black sheet. When white unevenness of the coated film was observed in the hard coat film by visual inspection, the result is indicated with the symbol “x”, and when such unevenness was not observed, the result is indicated with the symbol “∘”.

### <Surface Hardness>

Pencil hardness of each hard coat film was measured for the hard coat layer side according to the pencil scratch test machine method defined in JIS-K 5400:1990. Evaluation was performed on the basis of scratch of the coated film. As for the results, pencil hardness not lower than 2H is indicated with the symbol “∘”, pencil hardness of from B to 2B is indicated with the symbol “Δ”, and pencil hardness not higher than 4B is indicated with the symbol “x”.

### <Antiscratching Property>

For each of the hard coat films of the examples and comparative examples, the surface was reciprocally rubbed times with steel wool of #0000 under a load of 0.98 N/cm². When no scratch was seen on the surface, the result is indicated with the symbol “∘”, when there were certain scratches, the result is indicated with the symbol “Δ”, and when there were scratches, the result is indicated with the symbol “x”.

### <Appearance>

Each hard coat film was evaluated by visual inspection with transmitting light. When uneven light transmission was observed due to unevenness of the hard coat layer surface of the hard coat film or uneven coating, the result is indicated with the symbol “x”, when slight unevenness was observed, the result is indicated with the symbol “Δ”, and when unevenness was not observed, the result is indicated with the symbol “∘”.

TABLE 1

| | | Anti- | | | Anti- | |
|---|---|---|---|---|---|---|
| | Antistatic | reflection | | Surface | scratching | |
| | property | property | Whitening | hardness | property | Appearance |
| Example 1 | ∘ | ∘ | ∘ | ∘ | ∘ | ∘ |
| Example 2 | ∘ | ∘ | ∘ | ∘ | ∘ | ∘ |
| Example 3 | ∘ | ∘ | ∘ | ∘ | ∘ | ∘ |
| Example 4 | ∘ | ∘ | ∘ | Δ | Δ | ∘ |
| Example 5 | ∘ | ∘ | ∘ | ∘ | ∘ | Δ |
| Example 6 | ∘ | ∘ | ∘ | Δ | Δ | ∘ |
| Comparative | x | Δ | ∘ | ∘ | ∘ | x |
| Example 1 | | | | | | |
| Comparative | ∘ | x | ∘ | ∘ | ∘ | Δ |
| Example 2 | | | | | | |
| Comparative | x | Δ | ∘ | ∘ | ∘ | ∘ |
| Example 3 | | | | | | |
| Comparative | ∘ | ∘ | x | x | x | ∘ |
| Example 4 | | | | | | |

The antistatic hard coat films of Examples 1 to 3 had an antistatic hard coat layer containing a polymer antistatic agent having an organopolysiloxane unit and a quaternary ammonium salt unit on a base material. Therefore, the antistatic hard coat films of Examples 1 to showed superior results in evaluation for all of antistatic property, antireflection property, whitening, surface hardness and antiscratching property. Moreover, since the antistatic hard coat film of Example 1 contained a resin having ultraviolet absorbing property as the ionizing radiation curable resin, the film showed superior light resistance.

The antistatic hard coat film of Example 4 also had an antistatic hard coat layer containing a polymer antistatic agent having an organopolysiloxane unit and a quaternary ammonium salt unit on a base material. However, since the hard coat film of Example 4 contained a large amount of the polymer antistatic agent having an organopolysiloxane unit and a quaternary ammonium salt unit, it showed surface hardness and antiscratching property inferior to those of the antistatic hard coat films of Examples 1 to 3. It showed superior results for antistatic property, antireflection property and whitening.

The antistatic hard coat film of Example 5 contained only a small amount of the antistatic agent (20% by weight). Although it showed results equivalent to those of the antistatic hard coat films of Examples 1 to 3 for the evaluation items except for appearance, it showed appearance inferior to that of the films of the other examples, since the leveling effect of the organopolysiloxane was insufficient, and thus unevenness was generated in the coated film.

The antistatic hard coat film of Example 6 contained the pigment at a content of 6% by weight, i.e., contained more pigment than the films of the other examples. Therefore, it showed surface hardness and antiscratching property inferior to those of the films of the other examples. Moreover, although unevenness was not observed concerning appearance, haze was also slightly high due to the addition of the pigment. It showed evaluation results equivalent to those of the films of Examples 1 to 3 for the items other than surface hardness and antiscratching property.

The hard coat film of Comparative Example 1 did not contained the antistatic agent in the hard coat layer. Therefore, the hard coat film of Comparative Example 1 showed inferior antistatic property. Moreover, since it did not utilize the polymer antistatic agent having an organopolysiloxane unit and a quaternary ammonium salt unit, antireflection effect could be obtained only by addition of the pigment, and it showed slightly inferior antireflection property.

The hard coat film of Comparative Example 2 contained a metal antistatic agent in the hard coat layer. Therefore, the hard coat film of Comparative Example 2 showed inferior antireflection property, even though it contained a pigment.

The hard coat film of Comparative Example 3 contained the polymer antistatic agent and a leveling agent in the hard coat layer. Therefore, since the leveling agent inhibited disposition of the antistatic agent on the hard coat layer surface, the hard coat film of Comparative Example 3 showed inferior antistatic property. Moreover, since it contained a polymer antistatic agent not having organopolysiloxane unit and quaternary ammonium salt unit, antireflection effect could be obtained only by addition of the pigment, and it showed slightly inferior antireflection property.

The hard coat film of Comparative Example 4 contained only the polymer antistatic agent having an organopolysiloxane unit and a quaternary ammonium salt unit in the hard coat layer. Therefore, the hard coat film of Comparative Example 4 showed inferior surface hardness. Furthermore, since it contained a large amount of the quaternary ammonium salt, it showed generation of white unevenness, which was not generated in the hard coat layers of Examples 1 to 4 containing the same polymer antistatic agent as that of Comparative Example 4.

1. An antistatic hard coat film comprising a base material and an antistatic hard coat layer formed from an ionizing radiation curable resin, a pigment and a polymer antistatic agent having an organopolysiloxane unit and a quaternary ammonium salt unit and provided on at least one surface of the base material, wherein content of the pigment is 1 to 5% by weight of the total solid content of the hard coat layer.

2. The antistatic hard coat film according to claim 1, wherein the content of the pigment is 3% by weight or less of the total solid content of the hard coat layer.

3. The antistatic hard coat film according to claim 1, wherein weight ratio of the ionizing radiation curable resin and the polymer antistatic agent is 8:2 to 4:6.

4. The antistatic hard coat film according to claim 3, wherein weight ratio of the ionizing radiation curable resin and the polymer antistatic agent is 6:4 to 5:5.

5. The antistatic hard coat film according to claim 4, wherein the pigment consists of resin beads.

6. The antistatic hard coat film according to claim 3, wherein the pigment consists of resin beads.

7. The antistatic hard coat film according to claim 2, wherein weight ratio of the ionizing radiation curable resin and the polymer antistatic agent is 8:2 to 4:6.

8. The antistatic hard coat film according to claim 7, wherein weight ratio of the ionizing radiation curable resin and the polymer antistatic agent is 6:4 to 5:5.

9. The antistatic hard coat film according to claim 8, wherein the pigment consists of resin beads.
